(19) United States
(12) Patent Application Publication
(10) Pub. No.: US 2026/0080590 A1
(43) Pub. Date: Mar. 19, 2026

(54) METHOD FOR DISPLAYING AND GENERATING IMAGES USING GENERATIVE AI BASED ON HISTORY DATA

(71) Applicant: CANON KABUSHIKI KAISHA, Tokyo (JP)

(72) Inventors: HIROFUMI MOCHIZUKI, Saitama (JP); KOHEI TODA, Kanagawa (JP)

(21) Appl. No.: 19/327,878

(22) Filed: Sep. 12, 2025

(30) Foreign Application Priority Data
Sep. 18, 2024 (JP) 2024-161516

(51) Int. Cl. G06T 11/60; G06F 3/12

(52) U.S. Cl. CPC G06T 11/60; G06F 3/1208; G06F 3/1256; G06F 3/1287

(57) ABSTRACT

An information processing apparatus and method is provided and includes displaying a history including an image generated based on a prompt input by a user and an image of input first image data, and displaying an image generated based on a prompt included in a history selected from the displayed history and an image of input second image data.

### BACKGROUND

### Field of the Technology

The present disclosure relates to a storage medium, an information processing apparatus, and an information processing method.

### Description of the Related Art

In recent years, there has been rapid development of conversational artificial intelligence (AI) such as chatbots and generative AI. Along with this devolvement, various services using conversational AI have been provided. Japanese Patent Laid-Open No. 2024-25293 describes a system in which an image is displayed and edited based on a prompt input by a user.

There may be cases where a user desires to edit an image (generate an image) in a manner similar to a previously-edited image although the image to be edited is different from the image previously edited by the user. In such a case, it takes time and effort for the user to input the similar prompt again.

### SUMMARY

The present disclosure has been made in view of the above-described issue and is directed to reducing user's time and effort to generate an image using a previously input prompt.

According to an aspect of the present disclosure, a method comprising displaying, on a display screen, history data including one or more images generated using generative artificial intelligence (AI), each of the one or more images having been generated based on a prompt input by a user and input first image data and displaying, on the display screen, a generated image that is generated using the generative AI and is based on input second image data and selected history data from the displayed history data, the selected history data including the prompt.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of an overall configuration of a system.

FIG. 2 is a block diagram illustrating an example of a hardware configuration of a computer in the system.

FIG. 3 is a block diagram illustrating an example of a hardware configuration of a generative artificial intelligence (AI) server in the system.

FIG. 4 is a block diagram illustrating an example of a hardware configuration of a printer in the system.

FIG. 5 is a block diagram illustrating an example of a software configuration of the system.

FIG. 6 is a diagram illustrating an example of a printing application screen in the system.

FIG. 7 is a diagram illustrating an example of a history display screen for the printing application in the system.

FIG. 8 is a table illustrating an example of a history data structure in the system.

FIGS. 9A and 9B each illustrate an example of a setting screen for the printing application.

FIGS. 10A and 10B are a sequence diagram illustrating an example of processing of image conversion via chat and printing.

FIG. 11 is a sequence diagram illustrating an example of history data display and history data application processing.

FIG. 12 is a flowchart illustrating an example of processing performed by the printing application.

FIG. 13 is a flowchart illustrating an example of processing performed by the generative AI server.

FIG. 14 is a flowchart illustrating an example of processing performed by the printing application.

FIG. 15 is a flowchart illustrating an example of processing performed by the printing application.

### DESCRIPTION OF THE EMBODIMENTS

Hereinafter, embodiments will be described in detail with reference to the accompanying drawings. The following embodiments do not limit the disclosure according to the claims. While a plurality of features is described in the embodiments, not all of the features are necessarily essential to the disclosure, and the plurality of features may be combined as desired. Furthermore, in the accompanying drawings, the same reference numerals are given to the same or similar configurations, and redundant description will be omitted.

### System Configuration

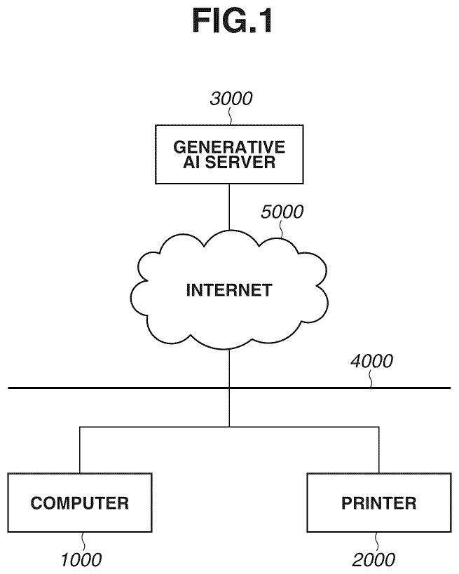

A network configuration of a printing system according to an embodiment of the present disclosure will now be described below with reference to FIG. 1.

As illustrated in FIG. 1, the printing system includes a computer 1000, which is, for example, a terminal apparatus or an information processing apparatus, a printer 2000, which is an example of a printing apparatus, and a generative artificial intelligence (AI) server 3000. For example, the computer 1000 and the printer 2000 are placed in an office and are connected to be communicable with each other via an in-house network 4000. The in-house network 4000 is connected to an external Internet 5000 via a router (not illustrated). In FIG. 1, the computer 1000 is an example of a user terminal or an information processing apparatus, and the generative AI server 3000 is an example of a server apparatus. A generative AI used herein refers to an AI that generates content such as image data, text, or audio based on an instruction indicated by a prompt that has been input. For example, in a case where a user inputs image data and a prompt to change a layout of the image data, the generative AI generates image data based on the input image data and the prompt input by the user.

The generative AI server 3000 is communicably connected to the computer 1000 and the printer 2000 via the Internet 5000 and the in-house network 4000.

### Hardware Configuration

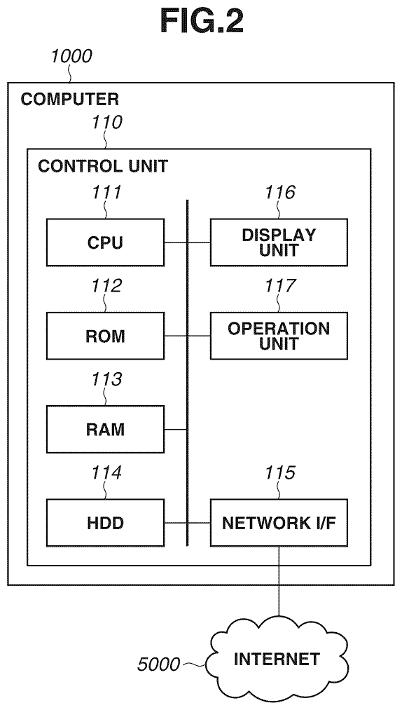

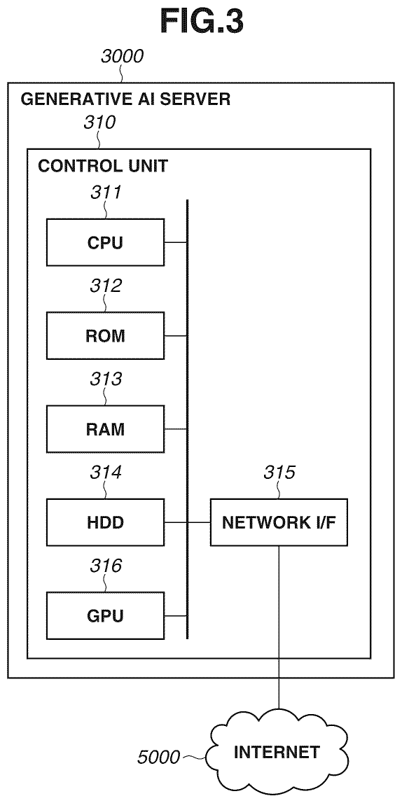

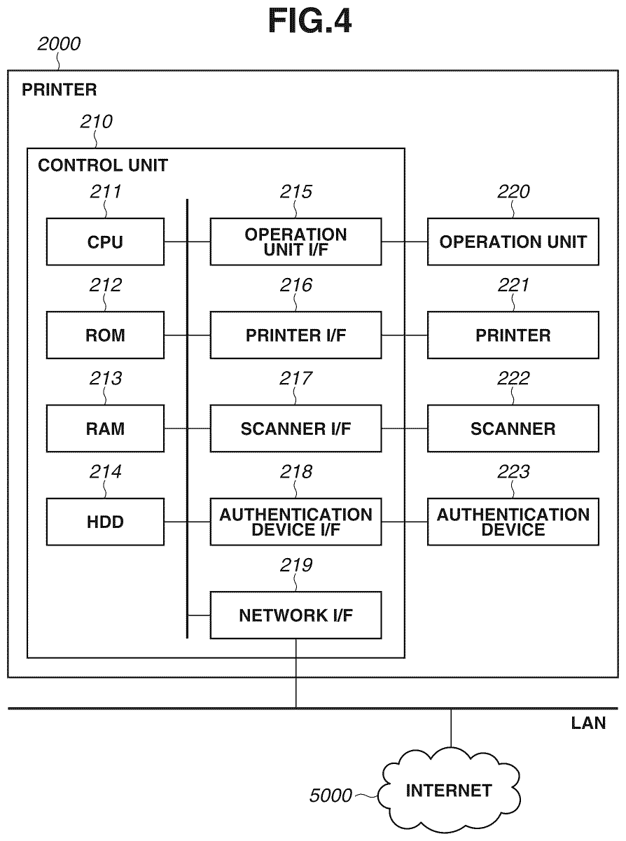

A hardware configuration of each apparatus in the printing system according to the present embodiment will be described with reference to FIGS. 2, 3, and 4. FIG. 2 illustrates an example of a hardware configuration of the computer 1000. FIG. 3 illustrates an example of a hardware configuration of the generative AI server 3000. FIG. 4 illustrates an example of a hardware configuration of the printer 2000.

As illustrated in FIG. 2, a control unit 110 of the computer 1000 includes a central processing unit (CPU) 111, a read-only memory (ROM) 112, a random access memory (RAM) 113, a hard disk drive (HDD) 114, and a network interface (I/F) 115. The computer 1000 also includes a display unit 116 and an operation unit 117. The CPU 111 reads control programs stored in the ROM 112 and executes various kinds of processing, thereby controlling operation of the entire computer 1000. The RAM 113 is used as a temporary storage area such as a main memory or a work area for the CPU 111. The HDD 114 is a large-capacity storage unit that stores image data and various programs. The network I/F 115 is an interface for connecting to the Internet 5000. A processing request is received from another apparatus or service via the network I/F 115, and various kinds of information is transmitted and received.

The display unit 116 is a display device such as a monitor. The display unit 116 may be integrated with the computer 1000, or may be connected to the computer 1000 as an external device. Screen information output from the CPU 111 is displayed on the display unit 116.

The operation unit 117 is an input device such as a keyboard and a mouse. The operation unit 117 may be integrated with the computer 1000, or may be connected to the computer 1000 as an external device. The CPU 111 receives various operations from the user via the operation unit 117.

Configurations of a CPU 311, a ROM 312, a RAM 313, a HDD 314, and a network I/F 315 in the generative AI server 3000 illustrated in FIG. 3 are respectively similar to the configurations of the CPU 111, the ROM 112, the RAM 113, the HDD 114, and the network I/F 115 in the computer 1000. Accordingly, in the present embodiment, the description of the hardware configuration of the generative AI server 3000 is omitted. The generative AI server 3000 can include a graphics processing unit (GPU) 316.

The printer 2000 illustrated in FIG. 4 includes a control unit 210, an operation unit 220, a printer 221, a scanner 222, and an authentication device 223. The control unit 210 controls operation of the entire printer 2000. A CPU 211 reads control programs stored in a ROM 212, and executes and controls various functions such as scanning, printing, and communication functions of the printer 2000. A RAM 213 is used as a temporary storage area such as a main memory or a work area for the CPU 211. In the present embodiment, the single CPU 211 uses a single memory (the RAM 213 or a HDD 214) to execute each processing in flowcharts to be described below. However, the present embodiment is not limited thereto.

For example, processing may be executed by causing a plurality of CPUs and a plurality of RAMs or HDDs to cooperate with one another. The HDD 214 is a large-capacity storage unit that stores image data and various programs. An operation unit I/F 215 is an interface for connecting the operation unit 220 and the control unit 210 to each other. The operation unit 220 includes a touch panel and a keyboard, and receives an operation, an input, and an instruction from the user. A printer I/F 216 is an interface for connecting the printer 221 and the control unit 210 to each other. Image data for printing is transferred to the printer 221 from the control unit 210 via the printer I/F 216, and the image data is printed on a recording medium such as a sheet. A scanner I/F 217 is an interface for connecting the scanner 222 and the control unit 210 to each other. The scanner 222 reads a document placed on a platen glass (not illustrated) or an auto document feeder (ADF) to generate image data, and outputs the image data to the control unit 210 via the scanner I/F 217. The printer 2000 can print out (copy) image data generated by the scanner 222 from the printer 221 and can transmit a file and an electronic mail (e-mail). An authentication device I/F 218 is an interface for connecting the authentication device 223 and the control unit 210 to each other. The authentication device 223 is, for example, a card reader that reads an integrated circuit (IC) card, or a fingerprint authentication device that reads a fingerprint, and is used when the user performs authentication to use the printer 2000. A network I/F 219 is an interface for connecting the control unit 210 (printer 2000) to a local area network (LAN). The printer 2000 transmits image data and information to each service on the Internet 5000 and receives various kinds of information via the network I/F 219.

### Software Configuration

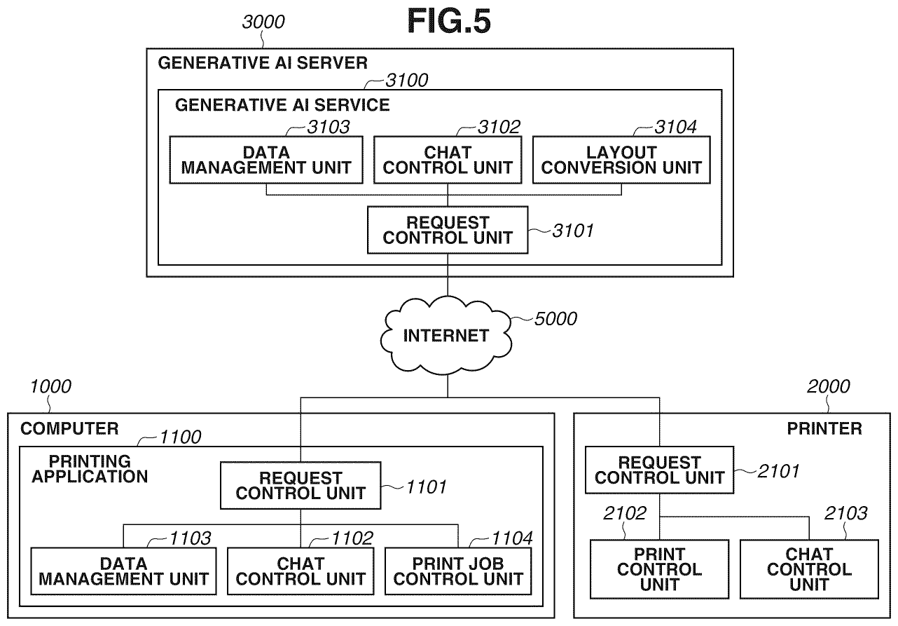

A software configuration of each apparatus included in the printing system according to the present embodiment will be described with reference to FIG. 5.

As illustrated in FIG. 5, a printing application 1100 is installed on the computer 1000. The printing application 1100 is an application for instructing the printer 2000 to perform printing. The printing application 1100 is an application configured to display a preview of an image to be printed, receive print settings, and transmit a print job to the printer 2000. In other words, the printing application 1100 can display an image and receive settings. The printing application 1100 may be an independent application, or may be an application integrated with a printer driver incorporated in an operating system (OS).

The printing application 1100 includes a request control unit 1101, a chat control unit 1102, a data management unit 1103, and a print job control unit 1104. The request control unit 1101 stands by in a state capable of receiving a request from each of the computer 1000, the printer 2000, and the generative AI server 3000, and causes each unit of the printing application 1100 to execute processing in response to the request. The chat control unit 1102 transmits a prompt (instruction message) and print data input from the user to the generative AI server 3000. Further, the chat control unit 1102 displays data received from the generative AI server 3000. The data management unit 1103 manages data to be used by the printing application 1100. Data to be managed may be application settings to be used by the printing application 1100, print data to be used by the printing application 1100, information input to the chat control unit 1102, and the like. The print job control unit 1104 converts print data generated by the printing application 1100 and the generative AI server 3000 into data in a format that can be printed by the printer 2000, and transmits the data as a print job to the printer 2000. Instead of converting print data by the print job control unit 1104, print data in a format that can be directly printed by the printer 2000 may be used.

The printer 2000 includes a request control unit 2101, a print control unit 2102, and a chat control unit 2103. The request control unit 2101 stands by in a state capable of receiving a request from each of the computer 1000, the printer 2000, and the generative AI server 3000. The print control unit 2102 executes a print job received from the computer 1000. The received print job may be executed immediately, or may be held until a print instruction is input from the user via the operation unit 220 and then may be executed. The chat control unit 2103 transmits a prompt and print data input from the user to the generative AI server 3000. Further, the chat control unit 2103 displays data received from the generative AI server 3000.

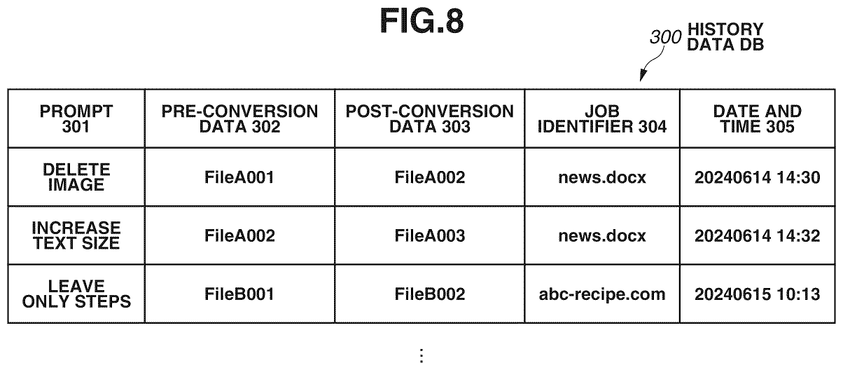

The generative AI server 3000 includes a generative AI service 3100. The generative AI service 3100 includes a request control unit 3101, a chat control unit 3102, a data management unit 3103, and a layout conversion unit 3104. The request control unit 3101 that includes a generative AI interpretation processing function and a print data layout change function stands by in a state capable of receiving a request from each of the computer 1000, the printer 2000, and the generative AI server 3000, and causes each unit included in the generative AI service 3100 to execute processing in response to the request. The chat control unit 3102 includes the generative AI interpretation processing function. The chat control unit 3102 interprets the received prompt described in a natural language and the received print data, and determines a response to the prompt and layout conversion processing to be performed on the print data. The layout conversion unit 3104 receives the layout conversion processing interpreted by the chat control unit 3102 and executes the layout conversion processing. In the present embodiment, the chat control unit 3102 and the layout conversion unit 3104 are described as separate processing units, but instead, may execute the processing integrally as one conversion processing unit. The data management unit 3103 stores and manages the received prompt, the received print data, and the converted print data as a history in association with information that identifies information about the user who has issued the instruction. An example of history data to be stored herein will be described below with reference to FIG. 8.

### Example of Printing Application Screen

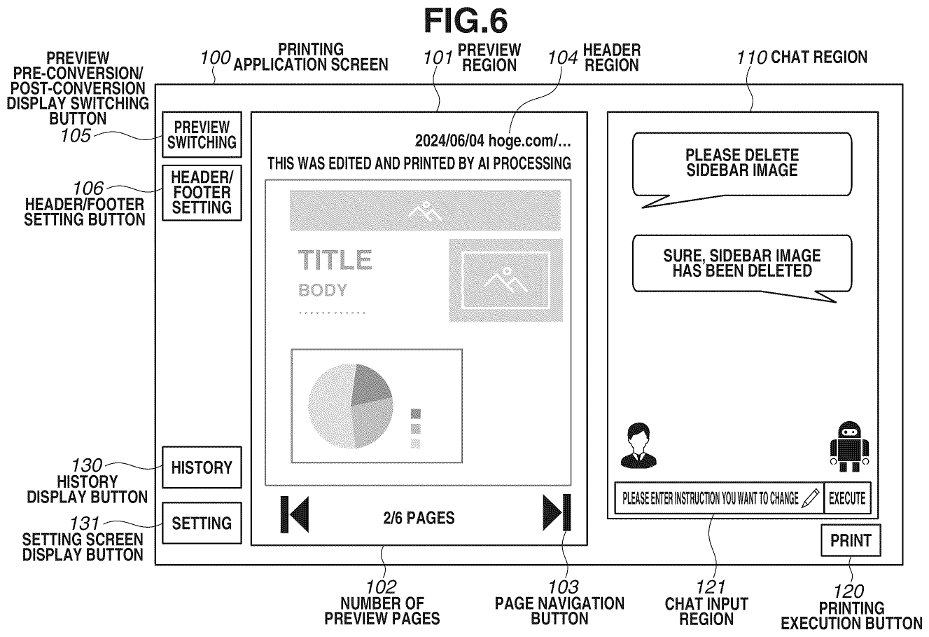

An example of a printing application screen 100 will be described with reference to FIG. 6. The printing application screen 100 includes a preview region 101, a chat region 110, and other objects. The printing application screen 100 is displayed on the display unit 116 of the computer 1000.

The preview region 101 is a region for displaying an image of image data to be transmitted from the printing application 1100 to the printer 2000 as a preview image. The region enables the user to preliminarily check a print product to be printed by the printer 2000 before the print product is output. The chat region 110 receives the input of the prompt from the user that is described in a natural language, and displays the prompt therein. The preview region 101 and the chat region 110 update the display every time a response is received from the generative AI server 3000.

In the present embodiment, first, a print preview of data, such as image data input from the user and a website address of a website designated by the user, is displayed in the preview region 101. The chat region 110 accepts a prompt in natural language form from the user. The accepted prompt is for editing the print data. Display of the preview region 101 is updated with received print data every time print data generated by the generative AI server 3000 based on the input prompt and original image data is received.

The preview region 101 includes a number of preview pages 102, a page navigation button 103, a header region 104, a preview pre-conversion/post-conversion display switching button 105, and a header/footer setting button 106. The number of preview pages 102 includes the total number of pages, when printed, of print data (image data) currently displayed, and a page number of a page currently displayed on the preview region 101. The page navigation button 103 is a button for changing the preview displayed in the preview region 101 by returning the currently displayed page to the previous page or advancing the currently displayed page to the next page. The header region 104 displays a preview of a header to be printed during printing. The header may be included in print data, or may be displayed during preview. In other words, information included in the header region 104 may be or may not be printed.

The header can include a print date and time and a print target name such as a name of a file to be printed or a Uniform Resource Locator (URL) from which image data to be printed is acquired. In a case where print data is generated by the generative AI service 3100 and the print data is displayed in the preview region 101, the header includes information indicating that the print data has been generated by a generative AI. For example, a character string such as “this was edited and printed by AI processing” or “this is an image generated by a generative AI” may be displayed and printed in the header region 104. Instead of displaying and printing the information indicating that the print data is generated by the generative AI in the header region 104, the information may be displayed and printed within a footer region, within another margin, or within an image of image data. When the preview pre-conversion/post-conversion display switching button 105 is pressed, a preview to be displayed in the preview region 101 is switched between a current preview image and an unedited preview image received when the printing application 1100 is activated. The display of the number of preview pages 102 is also switched simultaneously. In this case, the preview is displayed on the printing application screen 100 in such a manner that the user can distinguish the original preview image from the latest preview image. A screen for displaying only the latest preview image and a screen for displaying the unedited preview image and the latest preview image side by side may be switched by pressing the preview pre-conversion/post-conversion display switching button 105.

The chat region 110 includes a chat input region 121. The chat input region 121 accepts a print data conversion instruction input by the user using a natural language. The printing application 1100 transmits the input print data conversion instruction and the print data to the generative AI service 3100. The printing application 1100 displays a character string indicating a conversion result received from the generative AI service 3100 as a chat response character string in the chat region 110. In FIG. 6, an instruction message “please delete a sidebar image” is input in the chat region 110, and as a response thereto, a conversion result indicating that the image has successfully been deleted is displayed therein.

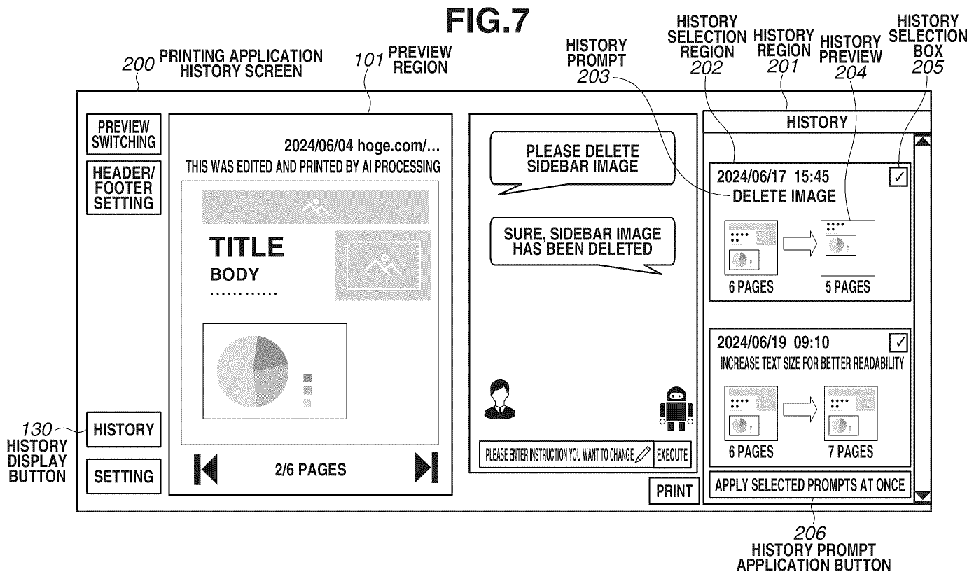

The printing application screen 100 includes other objects displayed therein. Other objects include a printing execution button 120, a history display button 130, and a setting screen display button 131. The printing execution button 120 is a button for the printing application 1100 to start processing of transmitting a print job for printing on the printer 2000. When the printing execution button 120 is selected, the print job including image data corresponding to the image displayed in the preview region 101 when the printing execution button 120 is selected is transmitted to the printer 2000. The history display button 130 is a button for displaying a user interface (UI) to display a previous print data conversion history. FIG. 7 illustrates a screen for the previous print data conversion history. The setting screen display button 131 is a button for displaying a setting screen for the printing application 1100 (not illustrated) when pressing of the setting screen display button 131 is detected. The setting screen includes, for example, a printer selection object for selecting a printer to be used for printing, a number-of-copies object for designating the number of copies to be printed, and a color setting object for designating a printing color. The setting screen also includes setting values for conversion and generation of print data to be performed by the generative AI server 3000. Examples of the setting values include setting values for disabling/enabling a conversion (generation) result history management, setting values for disabling/enabling processing of embedding a prompt used for conversion in print data, and setting values for disabling/enabling processing for the printing application 1100 to automatically perform conversion processing using an embedded prompt.

### Example of Printing Application History Screen

The printing application 1100 displays previous history data that enables selection of a previously input prompt and application of the prompt to current printing. A printing application history screen 200 will be described with reference to FIG. 7 as an example where the printing application 1100 according to the present embodiment displays a previous history on the computer 1000 or the printer 2000.

Descriptions of objects similar to those of the printing application screen 100 are omitted. When detecting that the history display button 130 is pressed, the printing application 1100 acquires history data from the generative AI service 3100, and displays a history region 201. While the history region 201 is displayed on the right side of the chat region in FIG. 7, the history region 201 may be displayed at another location, or may be displayed as another window.

The history region 201 includes a history selection region 202 and a history prompt application button 206. The history selection region 202 is present for each piece of history data, and thus the history region 201 includes a plurality of history selection regions 202. Each history selection region 202 includes a history prompt 203, a history preview 204, and a history selection box 205. The history selection region 202 may include a date and time of conversion of history data and a print target name such as a name of a file to be printed or a URL. The history prompt 203 indicates a prompt used for conversion of print data (prompt previously input to the chat input region 121 by the user). The history preview 204 displays a pre-conversion preview and a post-conversion preview side by side with regard to the conversion based on the history prompt 203. The history preview 204 may include a change in the number of pages before and after the conversion. Pages with a large number of differences in change as a result of conversion based on the history prompt 203 may be displayed in the history preview 204. The display of both the history prompt 203 and the history preview 204 in the history selection box 205 enables the user to check the prompt previously used and the image generation result based on the prompt, and to easily select a desired prompt. The history selection box 205 is a selection box for selecting a history prompt to be applied to the current print data. FIG. 7 illustrates a state where two history prompts, namely, “delete image” and “increase text size for better readability”, are selected. The history prompt application button 206 is a button for transmitting the plurality of currently selected history prompts and the current print data to the generative AI service 3100 when pressing of the history prompt application button 206 is detected. When the history prompt application button 206 is selected, the generative AI service 3100 sequentially applies the prompts to the print data. The printing application 1100 receives the conversion result obtained after applying all conversions, and reflects the conversion result in the preview region 101 and the chat region 110.

Specifically, when the history prompt application button 206 is selected in a state where the history selection box 205 is selected, the printing application 1100 transmits a prompt included in a selected history to the generative AI server 3000. Further, the printing application 1100 also transmits image data corresponding to an image currently displayed in the preview region 101 to the generative AI server 3000. Accordingly, the generative AI server 3000 generates (converts) image data based on the received prompt and the received image data. When receiving the image data generated by the generative AI server 3000, the printing application 1100 displays the image of the received image data in the preview region 101. Then, the user selects the printing execution button 120, thereby transmitting the image data received from the generative AI server 3000 to the printer 2000. At this time, a print job including the image data, print settings configured by the user on the printing application 1100, and the like is transmitted. Then, the printer 2000 that has received the print job executes the received print job and prints an image on a sheet.

In other words, the printing application 1100 can display a history including an image generated based on a prompt and an image of first image data input by the user.

The printing application 1100 can also display an image generated based on the prompt included in the selected history and an image of second image data input by the user. The second image data is different from the first image data previously input.

The printing application 1100 can transmit the prompt input by the user and the first image data input by the user to the generative AI server 3000. Further, the printing application 1100 can receive image data corresponding to the image generated based on the transmitted prompt and first image data. By performing such processing, it is possible to store a combination of a prompt transmitted in the processing and image data generated based on the prompt as history data. The user can check this history data in the history region 201. In other words, the history including the input prompt and an image of image data received from the generative AI server 3000 is displayed in the history region 201.

The printing application 1100 can transmit a prompt included in a history selected from the displayed history and the input second image data to the generative AI server 3000. Then, the printing application 1100 receives, from the generative AI server 3000, image data corresponding to the image generated based on the transmitted prompt, included in the selected history, and the image of the second image data. Then, the printing application 1100 displays the image of the received image data in the preview region 101. As in the screen illustrated in FIG. 7, a history is selected from a list of histories in a state where the second image data is displayed.

The printing application 1100 can accept print settings for a color mode, double-sided printing, a sheet size, and the like. When the printing execution button 120 is selected, the printing application 1100 transmits print settings designated by the user and image data corresponding to the image displayed in the preview region 101 to the printer 2000.

The printing application 1100 transmits the prompt included in the selected history and the second image data to the generative AI server 3000 without receiving the input of the prompt displayed in the history region 201 by the user after the history is displayed. Then, the generative AI server 3000 generates image data based on the prompt and the second image data. The printing application 1100 receives the generated image data. Then, the image of the image data is displayed in the preview region 101.

The preview region 101 displays the image generated based on the prompt included in the selected history and the image of the input second image data, and information indicating that the image is generated by the generative AI.

The above operation of the printing application 1100 is implemented by the CPU 111 of the computer 1000 executing the printing application 1100.

### History Data Structure

FIG. 8 illustrates the structure of history data to be stored in the data management unit 3103 of the generative AI service 3100. A table of history data DB 300 illustrated in FIG. 8 includes, as history data items, a prompt 301, pre-conversion data 302, post-conversion data 303, a job identifier 304, and a date and time 305. Each row in the history data DB 300 indicates a piece of history data. The prompt 301 indicates a prompt that is received by the generative AI service 3100 as a conversion request. The pre-conversion data 302 indicates print data obtained before conversion is performed based on the prompt. The post-conversion data 303 indicates print data obtained after the conversion is performed based on the prompt. The pre-conversion data 302 and the post-conversion data 303 may be stored as a file in an external storage, and information for identifying the file in the external storage may be stored in the history data DB 300, instead of directly storing print data in the history data DB 300. The job identifier 304 stores, for example, a file name of a file to be printed or a URL of a file to be printed. The date and time 305 indicates a date and time of the conversion performed based on the corresponding prompt. The history data DB 300 is stored in the HDD 314 of the computer 1000.

### Example of Printing Application File Metadata Use Screen

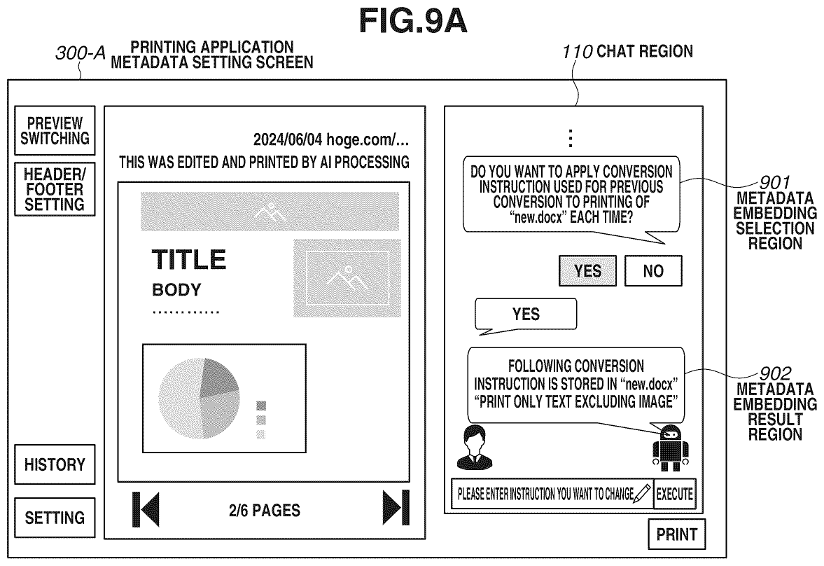

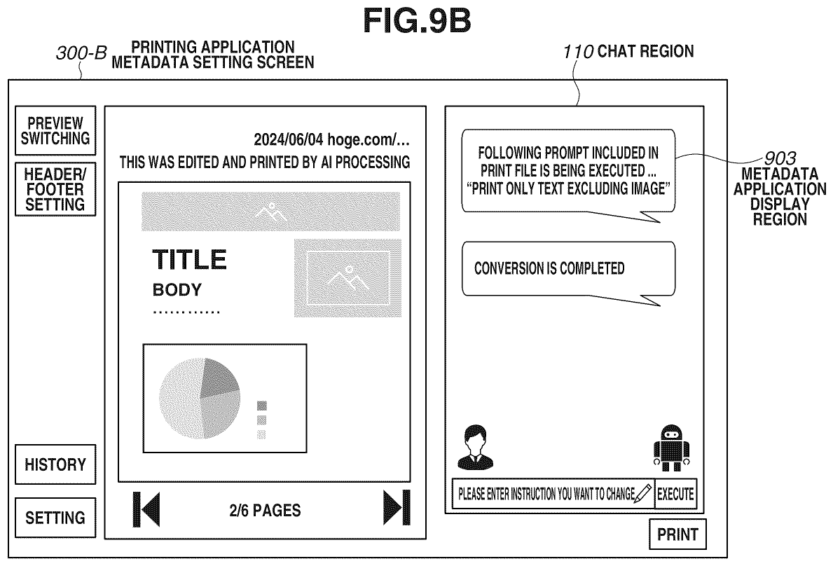

The printing application 1100 uses file metadata to reduce time and effort to input a similar prompt every time a file is printed. A printing application metadata setting screen 300-A according to the present embodiment and a printing application metadata application screen 300-B for applying file metadata as a prompt will be described with reference to FIGS. 9A and 9B. Descriptions of objects similar to those of the printing application screen 100 are omitted.

The printing application metadata setting screen 300-A will be described. When the printing execution button 120 is pressed, the printing application 1100 starts printing, and then displays a metadata embedding selection region 901 with regard to whether to embed a prompt used for the current conversion in a file to be printed in the chat region 110. The metadata embedding selection region 901 may also include an object for selecting whether to embed the prompt so that the user can easily make a response. Alternatively, the user may input a response using a natural language in the chat input region 121. Still alternatively, the user can make an input and a response such that a part of the input prompt or a new prompt that is not input is embedded. When a metadata embedding instruction is detected, the printing application 1100 embeds a prompt for conversion in metadata of a print file. After that, a metadata embedding result region 902 is displayed in the chat region 110.

An example where the metadata that has been embedded on the printing application metadata setting screen 300-A is loaded and used will be described with reference to the printing application metadata application screen 300-B for applying file metadata as a prompt. The printing application 1100 loads print data and checks whether metadata includes a prompt. If the metadata includes a prompt, a metadata application display region 903 is displayed. The metadata application display region 903 displays content of the embedded prompt and also displays information indicating that conversion based on the prompt is being executed. After completion of the conversion, the printing application 1100 reflects the conversion result in the preview region 101 and the chat region 110.

### Processing Flow

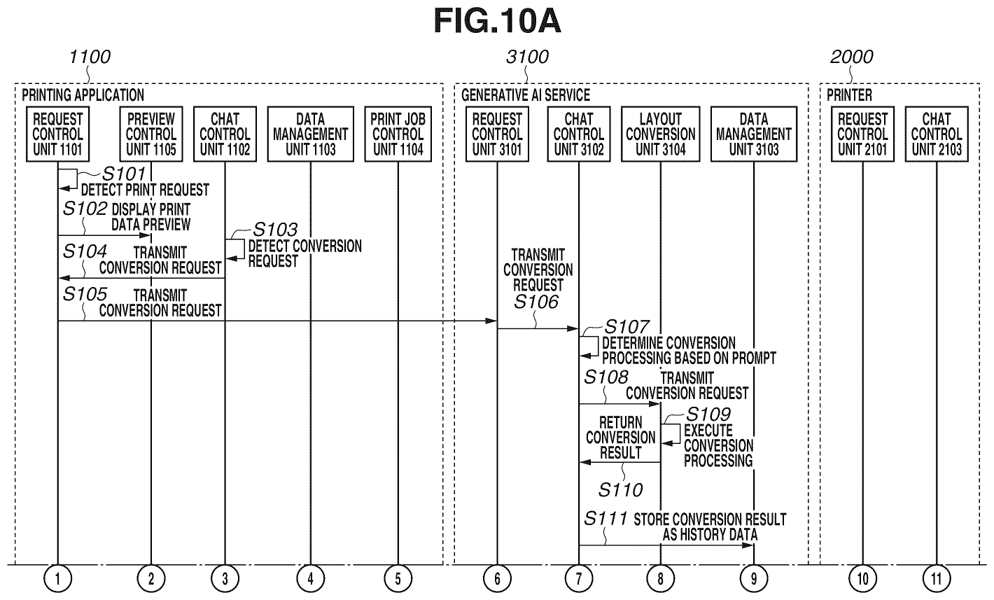

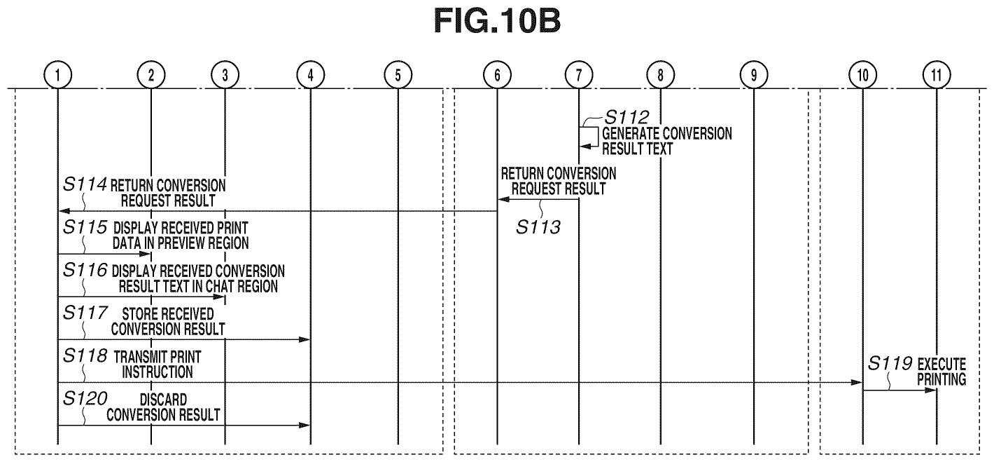

A sequence of layout conversion processing in the generative AI service 3100 according to the present embodiment will be described with reference to FIGS. 10A and 10B. A sequence of processing to be performed among the elements constituting the computer 1000, the printer 2000, and the generative AI service 3100 will be described. A number following “S” described below indicates a step number in the sequence.

In step S101, the request control unit 1101 of the printing application 1100 detects a print request from the computer 1000. The print request includes print data to be printed.

In step S102, the request control unit 1101 causes a preview control unit 1105 to display a preview of the received print data.

In step S103, the chat control unit 1102 of the printing application 1100 detects that a conversion request is input from the user. In step S104, the chat control unit 1102 transmits the conversion request to the request control unit 1101. In step S105, the request control unit 1101 transmits the conversion request to the request control unit 3101 of the generative AI service 3100. The conversion request includes the print data and a prompt input to the chat input region 121 from the user. In step S106, the request control unit 3101 transmits the conversion request to the chat control unit 3102. In step S107, the chat control unit 3102 interprets the received print data and prompt described in a natural language, and determines layout conversion processing to be performed on the print data. In step S108, the chat control unit 3102 transmits a request for the layout conversion processing to the layout conversion unit 3104. In step S109, the layout conversion unit 3104 executes the layout conversion processing included in the request for the layout conversion processing on the print data included in the request for the layout conversion processing. In step S110, the layout conversion unit 3104 returns a conversion result to the chat control unit 3102. In step S111, the chat control unit 3102 stores the conversion result as the history data in the data management unit 3103. FIG. 8 illustrates an example of the history data to be stored. In step S112, the chat control unit 3102 generates conversion result text indicating whether the conversion has been successful based on the conversion result received in step S107. In step S113, the chat control unit 3102 returns a conversion request result to the request control unit 3101. In step S114, the request control unit 3101 returns the conversion request result to the request control unit 1101 of the printing application 1100. The conversion request result includes the converted print data returned from the layout conversion unit 3104 in step S110 and the conversion result text generated in step S112.

In step S115, the request control unit 1101 causes the preview control unit 1105 to display a preview of the print data included in the received conversion request result. In step S116, the request control unit 1101 causes the chat control unit 1102 to display the conversion result text included in the received conversion request result in the chat region 110. In step S117, the request control unit 1101 stores the received conversion result in the data management unit 1103 of the printing application 1100. After that, steps S103 to S117 are repeated any number of times to generate print data with a layout desired by the user. While, in the present embodiment, print data is transmitted as a conversion request each time, the print data transmitted in step S105 may be stored in the data management unit 3103 of the generative AI service 3100 so as to reduce the amount of communication. Thus, second and subsequent conversion requests may include no print data, and the conversion processing in step S109 may be performed on the latest converted print data stored in the data management unit 3103. When print data desired by the user is generated, in step S118, the request control unit 1101 detects a print instruction and transmits the print instruction to the request control unit 2101 of the printer 2000. In step S119, the request control unit 2101 causes the print control unit 2102 to execute printing. In step S120, the request control unit 1101 of the printing application 1100 discards the conversion result that is no longer necessary from the data management unit 1103.

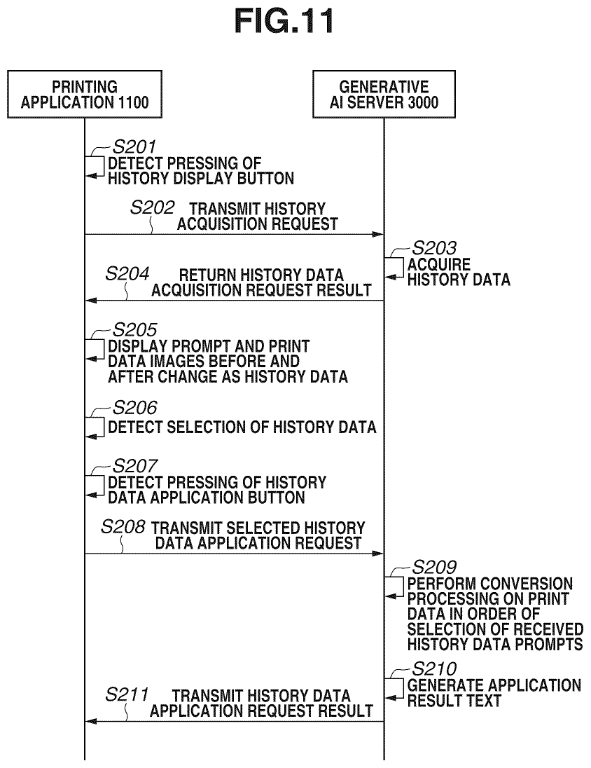

A sequence of processing of displaying a history and applying a history prompt to the current print data in the printing application 1100 according to the present embodiment will be described with reference to FIG. 11. A sequence of processing to be performed between the printing application 1100 and the generative AI server 3000 will be described.

In step S201, the printing application 1100 detects pressing of the history display button 130. In step S202, the printing application 1100 transmits a history acquisition request to the generative AI service 3100. In step S203, the generative AI service 3100 acquires history data from the data management unit 3103. The history data to be acquired in this step is history data about the user who has transmitted the history acquisition request. In step S204, the generative AI service 3100 returns a history data acquisition request result to the printing application 1100. The history data acquisition request result includes a plurality of history prompts, pre-conversion data and post-conversion data that are associated with the history prompts, date and time information, and a job identifier. In step S205, the printing application 1100 displays a set of history prompts included in the history data received in step S204 and images of print data before and after a conversion. If a plurality of histories is included, each of the plurality of histories is displayed as a set of history prompts and images. A change in the number of pages before and after a conversion may also be displayed. As the images of print data before and after a conversion to be displayed, pages with a large number of differences in change as a result of conversion based on the history prompts may be displayed.

This configuration enables the user to select a prompt to be applied to the current print data while checking the history data with reference to prompts and images before and after a conversion based on the prompts.

In step S206, the printing application 1100 detects selection of history data. This selection may be performed on a plurality of pieces of history data. When a plurality of pieces of history data is selected, the order of selection of the pieces of history data is stored. A UI for the printing application 1100 may display a selection number so that the user can recognize the order of selection of the pieces of history data. In step S207, the printing application 1100 detects pressing of a history data application button. In step S208, the printing application 1100 transmits a selected history data application request to the generative AI service 3100. The history data application request includes prompts for selected history data, the order of selection of the history data, and image data displayed in the current preview region 101. In step S209, the generative AI service 3100 performs interpretation of the prompts for the received history data according to the order of selection and performs layout conversion processing (image generation) on the print data. In step S210, the generative AI service 3100 generates text indicating a result of applying the history prompts. In step S211, the generative AI service 3100 transmits a history data application request result to the printing application 1100. The history data application request result includes the converted print data generated in steps S209 and S210 and the text indicating the conversion result.

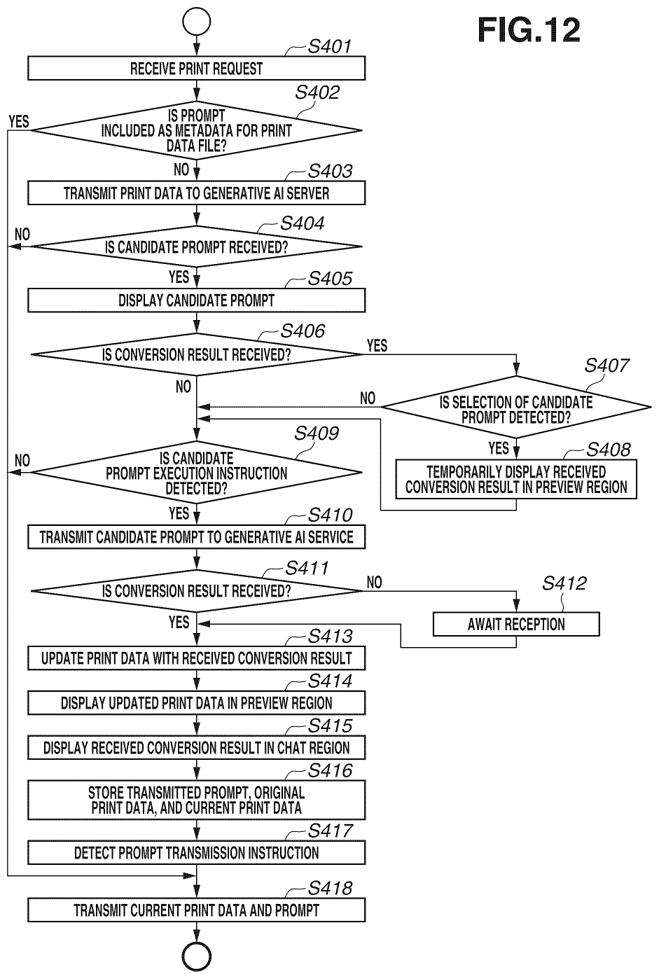

Processing for the printing application 1100 to automatically apply a prompt in a case where a prompt is embedded as metadata in a file to be printed and to provide a suggestion to the user to select a prompt suitable for print data using history data will be described with reference to FIG. 12.

In step S401, the printing application 1100 receives a print request from the computer 1000. In step S402, the printing application 1100 checks whether a print data file is included in the received print request, and whether a prompt is included as metadata of the file. It is checked whether the metadata indicates the prompt based on whether an identification character string defined by the printing application 1100 is included in a metadata name or in the metadata itself. If the prompt is included in the metadata (YES in step S402), the processing proceeds to step S418. In step S418, the current print data and the prompt are transmitted to the generative AI service 3100 so that the prompt can be executed immediately. If the prompt is not included (NO in step S402), the processing proceeds to step S403. In step S403, only the print data is transmitted to the generative AI server 3000. In step S404, the printing application 1100 checks whether the prompt to be a conversion candidate is received from the generative AI service 3100. If the prompt is not received (NO in step S404), the processing proceeds to step S418. The printing application 1100 determines that there is no conversion candidate, and then waits for an input of a prompt from the user and checks whether the input is detected. If the prompt is received (YES in step S404), the processing proceeds to step S405. In step S405, the printing application 1100 determines that there is a conversion candidate and displays the candidate prompt received in step S404 as an object that can be selected by the user in the chat region 110. In step S406, the printing application 1100 checks whether conversion data based on the candidate prompt is received. If the conversion data is not received (NO in step S406), the processing proceeds to step S409 without performing any further processing. If the conversion data is received (YES in step S406), the processing proceeds to step S407. In step S407, the printing application 1100 detects whether the object displayed in step S405 is selected. For example, it is determined that an action such as a mouseover or a long-press on the displayed object of the candidate prompt is detected. If the selection of the object is detected (YES in step S407), the processing proceeds to step S408. In step S408, the conversion data received in step S406 is temporarily displayed in the preview region 101 while the selection of the object is being detected. If the selection of the object is no longer detected, for example, if the mouse has been moved from the displayed object of the candidate prompt, the data to be displayed in the preview region 101 is changed to the original print data. This enables the user to easily check the conversion result before selecting a candidate prompt and determining a conversion. If the selection of the object is not detected (NO in step S407), the printing application 1100 does not perform any further processing even when the mouseover is detected, and then the processing proceeds to step S409. In step S409, the printing application 1100 detects whether the object corresponding to the candidate prompt is selected and an execution instruction is issued. If selection of the object is not detected (NO in step S409), the processing proceeds to step S418. The printing application 1100 determines that the candidate prompt is not selected, and then waits for an input of a prompt from the user and checks whether the input is detected. If the selection of object is detected (YES in step S409), the processing proceeds to step S410. In step S410, the printing application 1100 transmits the selected candidate prompt to the generative AI service 3100. In step S411, the printing application 1100 checks whether the conversion result of the candidate prompt transmitted in step S410 is already received. If the conversion result is not received yet (NO in step S411), the processing proceeds to step S412. In step S412, the printing application 1100 waits until the conversion result is received. If the conversion result is already received (YES in step S411), the processing proceeds to step S413. In step S413, the printing application 1100 updates the print data using the received conversion result.

In step S414, the printing application 1100 updates the preview region 101 with the print data updated in step S413. In step S415, the printing application 1100 displays the conversion result text received in step S412 in the chat region 110. In step S416, the printing application 1100 associates the transmitted prompt and original print data with the current print data obtained after conversion, and stores the associated print data in the data management unit 1103. Consequently, the printing application 1100 can implement the processing of automatically applying a prompt in a case where a prompt is embedded as metadata in a file to be printed and the processing of providing a suggestion to the user to select a prompt suitable for print data using history data. The printing application 1100 can subsequently receive an input of a prompt from the user and continue conversion processing. In step S417, the printing application 1100 detects a prompt transmission instruction. In step S418, the printing application 1100 transmits the current print data and the prompt to the generative AI service 3100, and then the processing of this flowchart ends.

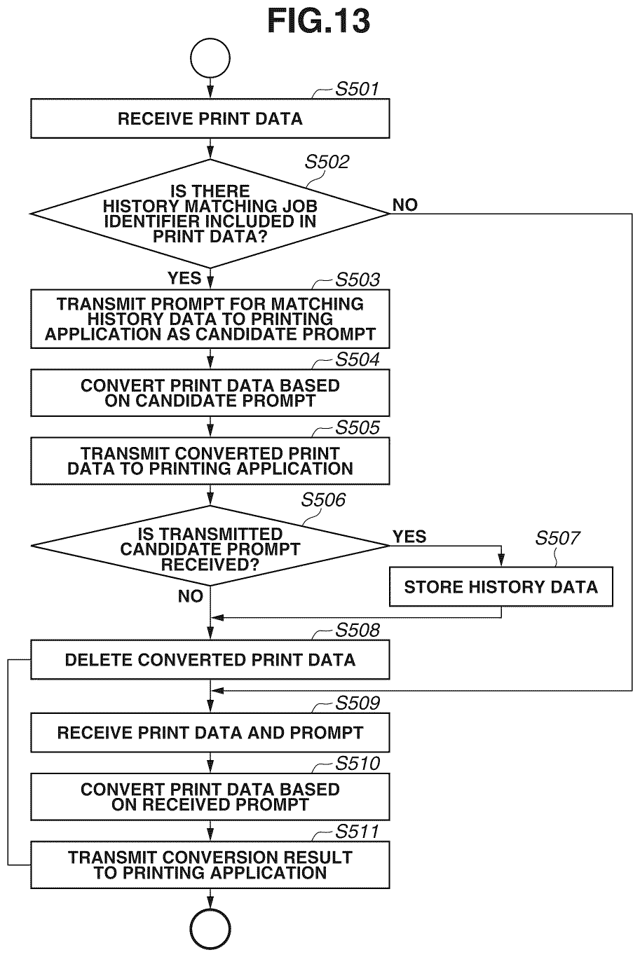

Processing for the generative AI service 3100 to provide a suggestion to the user to select a prompt suitable for received print data using history data will be described with reference to FIG. 13. In step S501, the generative AI service 3100 receives print data from the printing application 1100. In step S502, the generative AI service 3100 checks whether the history matching the job identifier included in the print data received in step S501 matches the job identifier 304 in the history data stored in the data management unit 3103, or whether there is similar history data. If there is no such history data (NO in step S502), the generative AI service 3100 does not generate a candidate prompt, and thus the processing proceeds to step S509 to perform prompt reception processing from the printing application 1100. If there is such history data (YES in step S502), the processing proceeds to step S503. In step S503, the generative AI service 3100 transmits the prompt 301 for the matching or similar history data to the printing application 1100 as a candidate prompt. In this case, in a case where there is a plurality of candidate prompts, the plurality of candidate prompts may be transmitted. In step S504, the generative AI service 3100 starts layout conversion based on the candidate prompt in advance before a candidate prompt execution instruction is received from the printing application 1100. If there is the plurality of candidate prompts, the layout conversion based on the plurality of candidate prompts is started. When the conversion is completed, in step S505, the generative AI service 3100 transmits the converted print data to the printing application 1100. Thus, conversion processing based on each candidate prompt is started in advance, thereby making it possible to reduce a waiting time for the user to use the printing application 1100 in a case where the candidate prompt is applied. In step S506, the generative AI service 3100 checks whether the candidate prompt transmitted in step S503 is received. If the candidate prompt is received (YES in step S506), the processing proceeds to step S507. In step S507, the generative AI service 3100 stores history data in the data management unit 3103. In step S508, the generative AI service 3100 deletes the print data converted based on the candidate prompt because the print data is no longer necessary. Even when no candidate prompt is received, in step S508, the generative AI service 3100 deletes the converted print data in the same way, assuming that the converted print data has not been selected. In step S509, the generative AI service 3100 receives the print data and the prompt from the printing application 1100. In step S510, the generative AI service 3100 interprets the prompt received in step S509, and performs conversion processing on the print data. In step S511, the generative AI service 3100 transmits the conversion result to the printing application 1100, and then the processing of the flowchart ends.

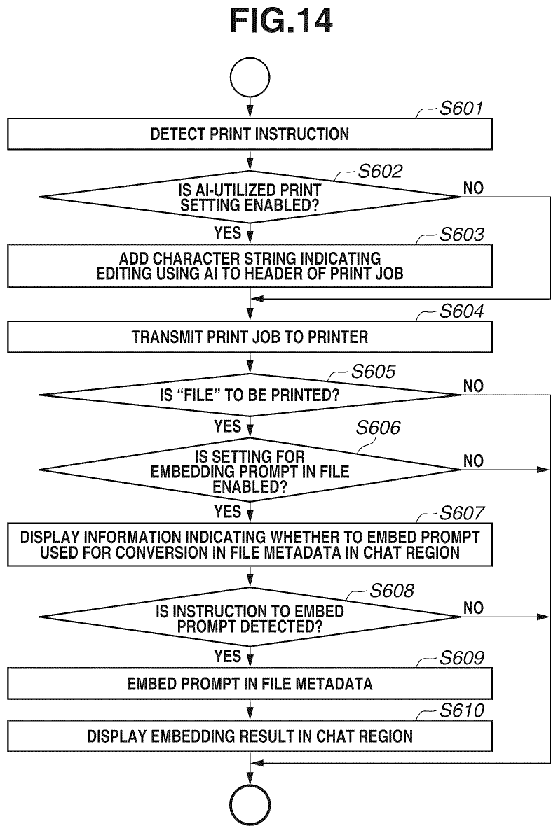

Processing for the printing application 1100 to perform printing by adding a header and to embed a prompt in file metadata will be described with reference to FIG. 14. In step S601, the printing application 1100 detects a print instruction issued when the printing execution button 120 is pressed. In step S602, the printing application 1100 checks whether an AI-utilized print setting is enabled as a setting for the printing application 1100. If the AI-utilized print setting is enabled (YES in step S602), the processing proceeds to step S603. In step S603, a character string indicating that this print product has been edited using AI is added to the header of the print job. As the character string, for example, text indicating that “this was edited and printed through AI processing” is printed. This enables the user who has seen a print product to recognize that the print product is not a direct printout of a file or a website. The character string indicating that the print product has been edited by AI may be set so that the character string is previewed and printed in a footer region, another margin of the print product, or a print body, instead of a header region. In step S604, the printing application 1100 creates a print job based on the current print data and transmits the print job to the printer 2000. In step S605, the printing application 1100 checks whether a “file” is to be printed. If what is to be printed is not a file (NO in step S605), the processing of this flowchart ends. If a file is to be printed (YES in step S605), the processing proceeds to step S606. In step S606, the printing application 1100 checks whether the setting for embedding a prompt in the file is enabled as a setting for the printing application 1100. If the setting is not enabled (NO in step S606), the processing of this flowchart ends. If the setting is enabled (YES in step S606), the processing proceeds to step S607. In step S607, the printing application 1100 displays information indicating whether to embed the prompt used for conversion as metadata in the file in the chat region 110. For example, a character string indicating that “Would you like to embed “delete the image” in “news. docs” to automatically apply this prompt from next time on?” is displayed together with character strings indicating “YES” and “NO” as button controls that can be pressed by the user. In step S608, the printing application 1100 checks whether an instruction to embed the prompt in metadata is detected. If the instruction is not detected (NO in step S608), the processing of this flowchart ends. If the instruction is detected (YES in step S608), the processing proceeds to step S609. In step S609, the printing application 1100 embeds the prompt in the file metadata. The metadata in which the prompt is embedded includes the prompt itself and an identifier for identifying the metadata as the prompt to be handled by the printing application 1100. For example, the identifier may be used as a metadata key name, or the identifier may be included in the metadata itself. In step S610, the printing application 1100 displays the embedding result in the chat region 110, and then the processing of this flowchart ends. Thus, the prompt is automatically applied from next time on when the printing application 1100 executes printing of a file.

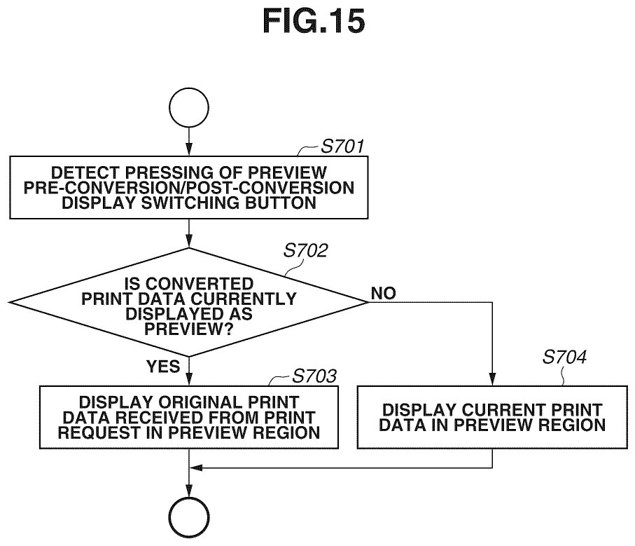

Processing for the printing application 1100 to switch previews before and after conversion will be described with reference to FIG. 15. In step S701, the printing application 1100 detects pressing of the preview pre-conversion/post-conversion display switching button 105. In step S702, the printing application 1100 checks whether the currently displayed preview is a preview of print data after conversion or a preview of original print data before conversion.

If the current preview image is a preview of print data after conversion (YES in step S702), the processing proceeds to step S703. In step S703, the printing application 1100 changes the display so that the original print data before the conversion is previewed. Then, the processing of this flowchart ends. At the same time, the display of the number of preview pages is also changed to the number of pages before the conversion. If the current preview image is a preview of the original print data before conversion (NO in step S702), the processing proceeds to step S704. In step S704, the printing application 1100 changes the display so that the latest print data after the conversion is previewed. Then, the processing of this flowchart ends. At the same time, the display of the number of preview pages is also changed to the number of pages before the conversion. Further, a screen for displaying only the latest preview and a screen for displaying the unedited preview and the latest preview side by side may be switched by pressing the preview pre-conversion/post-conversion display switching button 105.

As described above, in the printing system according to the present embodiment, the generative AI service 3100 performs layout conversion based on a prompt input to the printing application 1100 by the user using a natural language, and updates a print preview. The generative AI service 3100 stores the layout conversion history together with the prompt as print data before and after conversion, and displays the data as the history in the printing application 1100.

The above-described image data (print data) conversion processing and layout conversion processing may be processing of generating new image data based on the original image data and prompt.

While the above-described embodiments describe a case where the printing application 1100 runs on the computer 1000, the printing application 1100 may be allowed to run on the printer 2000, and conversion processing via chat may be performed on the printer 2000. In this case, as first processing for launching the printing application 1100, a print job is selected from a print job list for hold printing or a job history screen for print jobs in the printer 2000, and the printing application 1100 is started using the print job as print data.

According to the present disclosure, it is possible to reduce user's time and effort when the user generates an image using a prompt previously input.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-161516, filed Sep. 18, 2024, which is hereby incorporated by reference herein in its entirety.

What is claimed is:

1. A method comprising:
displaying, on a display screen, history data including one or more images generated using generative artificial intelligence (AI), each of the one or more images having been generated based on a prompt input by a user and input first image data; and
displaying, on the display screen, a generated image that is generated using the generative AI and is based on input second image data and selected history data from the displayed history data, the selected history data including the prompt.

2. The method according to claim 1, further comprising:
accepting an input of the prompt from the user; and
transmitting the input prompt and the input first image data to a generative artificial intelligence (AI) server; and
receiving the generated image data which is generated based on the transmitted input prompt and the transmitted input first image data,
wherein the history data including the input prompt and the image of the received generated image data is displayed.

3. The method according to claim 2, further comprising:
transmitting, to the generative AI server, the prompt included in the history data selected from the displayed history data and the input second image data;
receiving, from the generative AI server, a generated image that is generated by the generative AI server based on the transmitted prompt included in the selected history data and the input second image data; and
displaying the received image generated based on the received prompt included in the selected history data and the image of the input second image data.

4. The method according to claim 1, wherein the displayed history data is selectable in a state where the second image data is displayed.

5. The method according to claim 1, further comprising:
accepting a print setting; and
transmitting the print setting and the generated image data that is generated based on the prompt included in the selected history data and input second image data.

6. The method according to claim 1, wherein, after the history data is displayed, the image generated based on the prompt included in the selected history data and the image of the input second image data is displayed without accepting the input of the prompt from the user.

7. The method according to claim 1, wherein the history data includes the image generated based on the input prompt and the input first image data, and an image of the input first image data.

8. The method according to claim 1, further comprising displaying, on the display screen, an image generated based on the prompt included in the history data, a prompt input by the user, and the image of the input first image data.

9. The method according to claim 1, further comprising displaying, on the display screen, the image generated based on the prompt included in the selected history data and the input second image data, and information indicating that the image has been generated by a generative AI.

10. An information processing apparatus comprising:
at least one memory storing instructions; and
at least one processor that, upon execution of the stored instructions, configures the at least one processor to:
display, on a display screen, a history including an image generated based on a prompt input by a user and an image of input first image data; and
display, on the display screen, an image generated based on a prompt included in a history selected from the displayed history and an image of input second image data.

11. The information processing apparatus according to claim 10, wherein execution of the stored instructions further configures the at least one processor to:
accept an input of a prompt from the user;
transmit the input prompt and the input first image data to a generative AI server;
receive image data corresponding to an image generated based on the input prompt and the input first image data; and
display a history including the input prompt and the received image of the image data.

12. The information processing apparatus according to claim 11, wherein execution of the stored instructions further configures the at least one processor to:
transmit the prompt included in the history selected from the displayed history and the input second image data to the generative AI server;
receive an image generated based on the prompt included in the selected history and an image of the input second image data; and
display the image generated based on the prompt included in the selected history and the image of the input second image data.

13. The information processing apparatus according to claim 10, wherein the displayed history is selectable in a state where the second image data is displayed.

14. The information processing apparatus according to claim 10, wherein execution of the stored instructions further configures the at least one processor to:
accept a print setting; and
transmit, to a printing apparatus, the print setting and image data corresponding to the image generated based on the prompt included in the selected history and the image of the input second image data, the generated image being displayed on the display screen.

15. The information processing apparatus according to claim 10, wherein, after the history is displayed, the image generated based on the prompt included in the selected history and the image of the input second image data is displayed without accepting the input of the prompt from the user.

16. The information processing apparatus according to claim 10, wherein the history includes the image generated based on the input prompt and the image of the input first image data, and the image of the input first image data.

17. The information processing apparatus according to claim 10, wherein execution of the stored instructions further configures the at least one processor to display an image generated based on the prompt included in the history, the prompt input by the user, and the image of the input first image data.

18. The information processing apparatus according to claim 10, wherein execution of the stored instructions further configures the at least one processor to display the image generated based on the prompt included in the selected history and the image of the input second image data, and information indicating that the image has been generated by a generative AI.

19. An non-transitory computer readable storage medium storing a program that, when executed by an information processing apparatus, causes the information processing apparatus to execute a control method comprising:
displaying, on a display screen, history data including one or more images generated using generative artificial intelligence (AI), each of the one or more images having been generated based on a prompt input by a user and input first image data; and
displaying, on the display screen, a generated image that is generated using the generative AI and is based on input second image data and selected history data from the displayed history data, the selected history data including the prompt.
